(19) United States
(12) Patent Application Publication
(10) Pub. No.: US 2025/0305154 A1
(43) Pub. Date: Oct. 2, 2025

(54) ELECTRODES FOR ELECTROCHEMICAL WATER SPLITTING

(71) Applicant: King Abdullah University of Science and Technology, Thuwal (SA)

(72) Inventors: Cafer Tayyar YAVUZ, Thuwal (SA); Seokjin KIM, Thuwal (SA); Javeed MAHMOOD, Thuwal (SA)

(21) Appl. No.: 18/863,089

(22) PCT Filed: May 8, 2023
(86) PCT No.: PCT/IB2023/054767

§ 371 Date: Nov. 5, 2024

Related U.S. Application Data
(60) Provisional application No. 63/339,726, filed on May 9, 2022.

(51) Int. Cl. C25B 1/04; C25B 11/054; C25B 11/063; C25B 11/067; C25B 11/081; C25B 11/097

(52) U.S. Cl. CPC C25B 1/04; C25B 11/054; C25B 11/063; C25B 11/067; C25B 11/081; C25B 11/097

(57) ABSTRACT

An electrode composition includes one or more catalyst layers including one or more active catalytic metals and a tantalum oxide (TaxOy) support, and a substrate, wherein the one or more active catalytic metals include one or more of ruthenium, platinum, and iridium, and the one or more catalyst layers are in contact with the substrate.

### CROSS-REFERENCE TO RELATED APPLICATION

This application claims benefit of U.S. Provisional Application No. 63/339,726 filed on May 9, 2022. U.S. Provisional Application No. 63/339,726 is incorporated herein by reference. A claim of priority is made.

### BACKGROUND

Electrochemical water splitting is an emerging technology for producing renewable hydrogen fuel from water. Typically, hydrogen production includes the reforming of natural gas, which consumes a large amount of energy. Electrochemical water splitting produces hydrogen using electrical energy and electrodes, where electrocatalysis has typically been the major bottleneck. Further, conventional catalysts for electrochemical water splitting are high cost and have poor stability and/or activity. Developing active, stable, and low-cost electrocatalysts is important for achieving the desired efficiency for electrocatalytic hydrogen production from water. The development of electrocatalysts depends on the operational conditions of the water electrolysis method. One important operational condition includes the type of media utilized. Hence, designing optimal electrodes appropriate for various types of media with low-cost, stable, and active catalysts for electrolytic water splitting is important for efficient hydrogen production.

### SUMMARY

An electrode composition includes one or more catalyst layers including one or more active catalytic metals and a tantalum oxide (TaxOy) support, and a substrate, wherein the one or more active catalytic metals include one or more of ruthenium, platinum, and iridium, and the one or more catalyst layers are in contact with the substrate.

A method of making an electrode includes preparing an ink composition by contacting tantalum ethoxide or tantalum chloride with ruthenium chloride and an alcohol, coating the ink composition on a substrate, and heating the coated substrate.

A system for electrochemical water splitting includes an anode sufficient for an oxygen evolution reaction, a cathode sufficient for a hydrogen evolution reaction, an electrical energy source connected to the anode and the cathode, and an electrolyte, wherein the anode includes one or more catalyst layers including one or more active catalytic metals and a tantalum oxide (Ta₂O₅) support.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a schematic representation of a water-splitting system 100, according to some embodiments.

FIG. 2 illustrates a method of making an electrode, according to some embodiments.

FIG. 3 illustrates an example method of making an electrode, according to some embodiments.

FIG. 4 illustrates the application of catalyst ink on the conducting surface, according to some embodiments.

FIG. 5 illustrates an example of electrode materials including tantalum oxide supported ruthenium nanoparticles, according to some embodiments.

FIG. 6A illustrates a scanning electron microscopy (SEM) image of coating layer thickness, according to some embodiments.

FIG. 6B illustrates a SEM image of coating layer thickness, according to some embodiments.

FIG. 7 illustrates XRD analysis of ruthenium-catalyst on tantalum and titanium oxide, according to some embodiments.

FIG. 8 illustrates full water splitting hydrogen evolution reaction and oxygen evolution reaction (HER+OER) electrodes 1000 h stability test result at 40 mA/cm² current density in alkaline conditions, according to some embodiments.

FIG. 9A illustrates hydrogen evolution reaction (HER) performance (in alkaline conditions) including iR-corrected polarization curves of catalyst on tantalum oxide, Pt/C (20 Pt wt. %), and pure RuO₂, according to some embodiments.

FIG. 9B illustrates oxygen evolution reaction (OER) performance (in alkaline conditions) including iR-corrected polarization curves of catalyst on tantalum oxide, and pure RuO₂, according to some embodiments.

FIG. 10 illustrates the effect of tantalum on the catalyst electrode in alkaline conditions, according to some embodiments.

FIG. 11 illustrates the effect of bimetallic composition performance on the catalyst electrode in alkaline conditions, according to some embodiments.

FIG. 12A illustrates the effect of different bimetallic compositions on the performance of the catalyst electrode in alkaline conditions, according to some embodiments.

FIG. 12B illustrates the effect of different bimetallic compositions on the performance of the catalyst electrode in alkaline conditions, according to some embodiments.

FIG. 13A illustrates the effect of different bimetallic compositions on the HER performance of the catalyst electrode in acidic conditions, according to some embodiments.

FIG. 13B illustrates the effect of different bimetallic compositions on the OER performance of the catalyst electrode in acidic conditions, according to some embodiments.

FIG. 14A illustrates the hydrogen evolution reaction (HER) and oxygen evolution reaction (OER) stability (in alkaline conditions, 1.0 M of KOH) of the electrode, according to some embodiments.

FIG. 14B illustrates a linear sweep voltammogram (LSV) of hydrogen evolution reaction (HER) performance, initially and after 1000 hours in alkaline conditions, according to some embodiments.

FIG. 14C illustrates an LSV of oxygen evolution reaction (OER) performance, initially and after 1000 hours in alkaline conditions, according to some embodiments.

FIG. 15A illustrates full water splitting hydrogen evolution reaction and oxygen evolution reaction (HER+OER) electrodes 1000 h stability test result at 1000 mA/cm² current density in alkaline conditions, according to some embodiments.

FIG. 15B illustrates an LSV of full water splitting stability test in alkaline conditions (1.0 M of KOH), according to some embodiments.

### DETAILED DESCRIPTION

Embodiments of the present disclosure describe novel catalysts and approaches to improve electrochemical water splitting and hydrogen production. Two of the most important aspects of a catalyst for electrochemical water splitting are the activity and stability of the catalyst. Accordingly, both activity and stability are very important for the cathode and anode. Reduction may take place at the cathode. Conventional catalysts suffer from degradation, low catalytic activity, and poor stability. Therefore, there is a need for improved catalytic systems for efficient electrochemical water splitting and hydrogen production. The catalysts of the present disclosure have superior catalytic activity and stability for achieving the desired electrocatalytic hydrogen production from water.

Conventionally, four main types of electrolysis technologies are utilized: (1) proton exchange membrane (PEM) electrolysis, (2) alkaline water electrolysis (AWE), (3) high-temperature solid oxide water electrolysis (SOEC), and (4) anion exchange membrane (AEM) electrolysis. In a PEM-based electrolysis cell, water splitting is performed under acidic conditions using the proton exchange membrane. The prerequisite of acidic media may conventionally restrict the OER electrocatalysts to noble metal-based catalysts. For the alkaline water electrolysis cell, water splitting is achieved under alkaline conditions. In one example, water splitting in alkaline media may enlarge the range and choice of the electrocatalysts and may provide greater activity, stability, and efficiency in large scale applications. AEM is a type of electrolysis technology working in alkaline conditions using a membrane. AWE and AEM may require less energy to produce hydrogen and may operate at lower temperatures. The SOEC typically involves high energy intake due to the high temperature. Typically, SOEC suffers from material degradation due to these high temperatures. Long term stability and activity has traditionally been a challenge for these electrolysis technologies. Accordingly, a stable and efficient catalyst for water splitting in alkaline/acidic media may efficiently produce hydrogen for various applications.

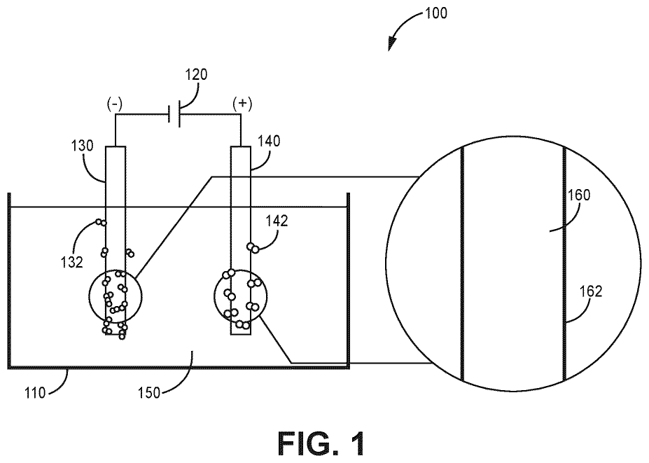

FIG. 1 illustrates a schematic representation of a water-splitting system 100, according to some embodiments. System 100 (or one or more components of system 100) may be utilized for PEM, AWE, SOEC, and AEM. System 100 includes optional reservoir 110, electrical energy source 120, cathode 130, anode 140, and electrolyte 150. System 100 may further include a diaphragm or separator. System 100 produces hydrogen gas 132 at cathode 130 and oxygen gas 142 at anode 140. The electrolyte 150 may be retained in the reservoir 110 and may be acidic, alkaline, solid oxide, or ceramic. The electrolyte 150 may be placed in contact with one or more of the cathode 130 and the anode 140. The optional reservoir 110 may be a tank, tube, or piping sufficient for holding, storing, and/or placing the electrolyte 150 in contact with the cathode 130 and/or the anode 140. Retaining may include holding the electrolyte 150 in place or position. Both the cathode 130 and/or the anode 140 may include a substrate 160 with one or more catalyst layers 162 in contact with the substrate 160. Both the cathode 130 and/or the anode 140 may include a substrate 160 with one or more catalyst layers 162 completely surrounding the substrate 160. Substrate 160 for cathode 130 and anode 140 is utilized to provide overall water splitting using electrical energy from the electrical energy source 120 and may include a conducting metal. System 100 may further include a membrane such as a membrane for AEM or a proton exchange membrane. Electrochemical water splitting includes an oxygen evolution reaction (OER) and a hydrogen evolution reaction (HER), which may occur simultaneously. The main reaction for electrochemical water splitting is shown as Equation 1 below, and a reaction for the cathode 130 (Equation 2) and the anode 140 (Equation 3) are also shown below. In one example, the cathode is negatively charged, and the anode is positively charged. Electrons from the cathode may be used to form hydrogen gas. Electrons may be transferred from the cathode to the anode to complete the circuit. Catalysts of the present disclosure may be utilized for both the cathode 130 and the anode 140-thus the catalysts may be utilized for OER and HER. The OER occurs at the anode 140, and the HER occurs at the cathode 130. Therefore, hydrogen and oxygen may be produced from water and/or an electrolyte using electricity. Conventionally, the same catalyst is not efficiently utilized as both an OER catalyst and an HER catalyst, and different cathode and anode materials may increase the cost of the water splitting process.

2H₂O+electric energy→2H₂+O₂ (Equation 1)

2H₂O+2e⁻→H₂+2OH⁻ (Equation 2)

20H−→O₂+H₂O+2e⁻ (Equation 3)

Catalysts of the present disclosure may include one or more catalyst layers including one or more active catalytic metals (such as metallic (reduced) or oxide (oxidized) forms) supported on a tantalum oxide (TaₓO_{y}) support. These catalysts may be in contact with a substrate. In one example, the one or more active catalytic metals include ruthenium. The one or more active catalytic metals may be in the metallic form or the oxide form. For HER, the metallic form, which refers to the reduced metal state (M⁰ or lower oxidation number), may be more suitable, as the reaction supplies electrons to the metal, allowing it to be reduced. Examples of the metallic form include Ru⁰, Ir⁰, and Pt⁰. For OER, the oxide form, which refers to the oxidized metal state (Mⁿ⁺), may be preferred due to its higher oxidation state that helps prevent deformation of the coating layer caused by the oxidation reaction. Examples of the oxide form include Ru⁴⁺ in RuO₂ and Ir⁴⁺ in IrO². In one example, using a form other than the oxide form for OER may cause oxidation and damage by expansion. In another example, the one or more active catalytic metals include one or more of ruthenium, platinum, and iridium and a secondary metal. The one or more active catalytic metals may two or more of ruthenium, platinum, and iridium. For example, the one or more active catalytic metals may include all of ruthenium, platinum, and iridium. In yet another example, the one or more active catalytic metals include ruthenium and one or more of platinum and iridium. An example molecular drawing is shown below to illustrate how the one or more active catalytic metals may be held over a tantalum oxide support. For example, precious metals may be included in the catalyst composition. In one non-limiting example, ruthenium may be selected as the active catalytic metal as it may be cheaper compared to platinum and iridium.

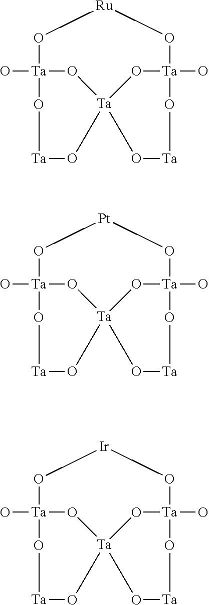

In one example, the catalyst includes one or more catalyst layers including ruthenium and a tantalum oxide support. In another example, the weight percentage of ruthenium in the catalyst ranges from about 1 wt. % to about 50 wt. %. In yet another example, the weight percentage of ruthenium in the catalyst ranges from about 1 wt. % to about 40 wt. %. In yet another example, the weight percentage of ruthenium in the catalyst ranges from about 1 wt. % to about 30 wt. %. For example, the weight percentage of ruthenium in the catalyst may range from about 1 wt. % to about 10 wt. %, or from about 10 wt. % to about 20 wt. %, or from about 20 wt. % to about 30 wt. %. For example, the weight percentage of ruthenium in the catalyst may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, and values therebetween. For example, the weight percentage of ruthenium in the catalyst may be about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, and values therebetween. The weight percentage of ruthenium in the catalyst may be less than 30 wt. %.

In one example, the catalyst includes one or more catalyst layers including platinum and a tantalum oxide support. In another example, the weight percentage of platinum in the catalyst ranges from about 1 wt. % to about 50 wt. %. In yet another example, the weight percentage of platinum in the catalyst ranges from about 1 wt. % to about 40 wt. %. In yet another example, the weight percentage of platinum in the catalyst ranges from about 1 wt. % to about 30 wt. %. For example, the weight percentage of platinum in the catalyst may range from about 1 wt. % to about 10 wt. %, or from about 10 wt. % to about 20 wt. %, or from about 20 wt. % to about 30 wt. %. For example, the weight percentage of platinum in the catalyst may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, and values therebetween. For example, the weight percentage of platinum in the catalyst may be about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, and values therebetween. The weight percentage of platinum in the catalyst may be less than 30 wt. %.

In one example, the catalyst includes one or more catalyst layers including iridium and a tantalum oxide support. In another example, the weight percentage of iridium in the catalyst ranges from about 1 wt. % to about 50 wt. %. In yet another example, the weight percentage of iridium in the catalyst ranges from about 1 wt. % to about 40 wt. %. In yet another example, the weight percentage of iridium in the catalyst ranges from about 1 wt. % to about 30 wt. %. For example, the weight percentage of iridium in the catalyst may range from about 1 wt. % to about 10 wt. %, or from about 10 wt. % to about 20 wt. %, or from about 20 wt. % to about 30 wt. %. For example, the weight percentage of iridium in the catalyst may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, and values therebetween. For example, the weight percentage of iridium in the catalyst may be about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, and values therebetween. The weight percentage of iridium in the catalyst may be less than 30 wt. %.

In one example, the one or more active catalytic metals includes ruthenium, platinum, or iridium, and a secondary metal. The secondary metal may include one or more of iridium, cobalt, nickel, iron, palladium, platinum, copper, and molybdenum. The secondary metal may include two or more of iridium, cobalt, nickel, iron, palladium, platinum, copper, and molybdenum. For example, the catalyst may include ruthenium and iridium, ruthenium and cobalt, ruthenium and nickel, ruthenium and iron, ruthenium and palladium, ruthenium and platinum, ruthenium and copper, and/or ruthenium and molybdenum. In one example, adding a secondary metal to the catalyst may enhance the activity of the catalyst and may enhance the lifetime of an electrode (cathode and/or anode) in alkaline or acidic conditions. In another example, adding a secondary metal to the catalyst may enhance the OER and/or the HER. In yet another example, adding a secondary metal may enhance the catalytic performance in water treatment and heterogeneous catalysis applications. In one non-limiting example, iridium, palladium, and/or cobalt as secondary metals may enhance OER. In one non-limiting example, palladium as a secondary metal is helpful in supporting electrodes with additional catalytic activity. In one non-limiting example, the secondary metal can reduce the total overpotential for producing hydrogen.

In one example, the weight percentage of the secondary metal(s) in the catalyst may range from about 0.01 wt. % to about 30 wt. %. In another example, the weight percentage of the secondary metal(s) in the catalyst may range from about 0.01 wt. % to about 15 wt. %. In yet another example, the weight percentage of the secondary metal(s) in the catalyst may range from about 0.01 wt. % to about 10 wt. %. For example, the weight percentage of the secondary metal(s) in the catalyst may range from about 0.1 wt. % to about 10 wt. %. For example, the weight percentage of the secondary metal(s) in the catalyst may be about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, and values therebetween. The weight percentage of the secondary metal(s) in the catalyst may be less than about 10 wt. %. In one example, a secondary metal with a weight percentage in the catalyst of about 0.1 wt. % to 10 wt. % increases the performance for one or more of the HER and the OER.

The catalyst may include the one or more active catalytic metals and the secondary metal(s) in various ratios. In one example, the weight ratio of the active catalytic metal to the secondary metal ranges from about 60:40 to about 99.9:0.1. In another example, the weight ratio of the active catalytic metal to the secondary metal ranges from about 90:10 to about 99.9:0.1. In yet another example, the weight ratio of the active catalytic metal to the secondary metal ranges from about 97:3 to 99.9:0.1. For example, the weight ratio of the active catalytic metal to the secondary metal may be about 97:3, about 98:2, about 99:1, about 99.5:0.5, about 99.9:0.1, and values therebetween. Even at weight ratios of the active catalytic metal to the secondary metal of 99:1 and 99.5:0.5, the secondary metal may increase the performance of the catalyst for water splitting. At weight ratios of the active catalytic metal to the secondary metal disclosed in the present paragraph, the Faradaic efficiency (or cell efficiency) may be increased by 0.1% to 20%. For example, the Faradaic efficiency may be increased by 10% by adding the secondary metal. Importantly, the secondary metal and the active catalytic metal may have a synergy effect to improve the cell efficiency. Without synergy between the secondary metal and the active catalytic metal, the efficiency could be decreased due to blocking of the active catalytic metal surface.

The support may include tantalum oxide (TaₓO_{y}). While metals such as ruthenium may act as an active catalytic metal, the tantalum oxide may be utilized for improved catalyst stability and for promoting activity. Tantalum oxide may not have catalytic activity by itself, but in combination with an active metal the system shows improved catalytic activity. For example, tantalum oxide may be chemically inert, making it very stable compared to other metal oxides. In one example, the tantalum oxide support includes tantalum pentoxide, including the formula Ta₂O₅. For example, the support may substantially or entirely include the orthorhombic form β-Ta₂O₅. Ta₂O₅ may be the major or dominate phase (such as more than 50%) of the support. Tantalum oxide is highly stable in harsh chemical conditions, especially in electrochemical conditions. This makes tantalum oxide an exceptional support for active metals and improves the catalytic activity of the catalyst.

In one example, tantalum oxide may include one or more of the orthorhombic form (β-Ta₂O₅), the hexagonal form (8-Ta₂O₅), the monoclinic form (α-Ta₂O₅), and the amorphous form. The orthorhombic form may be a stable polymorph of tantalum oxide at ambient conditions. The orthorhombic structure includes layers of TaO₆ octahedra, which are connected by corner sharing oxygen atoms. The hexagonal form has a hexagonal crystal structure and can be obtained at high temperatures (such as above 1360° C.) or under specific synthesis conditions. The hexagonal form may be less stable compared to the orthorhombic form and may revert to the orthorhombic form upon cooling. The monoclinic form may be produced at high pressure and using specific synthesis routes. The monoclinic form includes a monoclinic crystal structure and may be less stable than the orthorhombic form. The amorphous form may exist in a non-crystalline state, which can be produced by rapid quenching or deposition. Amorphous tantalum oxide has no longer-range atomic order and may exhibit different properties compared to its crystalline counterparts. While the dominant support phase may be Ta₂O₅, the support may include one or more of the following: TaM′O₃, Ta₂M′O₅, and Ta₂M′₂O₇, wherein M′ is selected from a secondary metal of the present disclosure. For example, Ti can form TaTiO₃, Ta₂TiO₅, and Ta₂Ti₂O₇.

In one example, the weight percentage of tantalum oxide in the catalyst ranges from 20 wt. % to 99 wt. %. In another example, the weight percentage of tantalum oxide in the catalyst ranges from 30 wt. % to 95 wt. %. In yet another example, the weight percentage of tantalum oxide in the catalyst ranges from 40 wt. % to 80 wt. %. For example, the weight percentage of tantalum oxide in the catalyst may range from 40 wt. % to 60 wt. %, from 50 wt. % to 70 wt. %, or from 60 wt. % to 80 wt. %. The weight percentage of tantalum oxide in the catalyst may be greater than 50%. The weight percentage of tantalum oxide in the catalyst may be greater than 60%. The weight percentage of tantalum oxide in the catalyst may be greater than 70%.

The one or more catalyst layers may include one or more metals such as titanium, tungsten, and zirconium. Titanium, tungsten, and/or zirconium may be added to the catalyst or substrate as an adhesive to improve adhesion between the catalyst and a substrate. For example, one or more of titanium n-butoxide, titanium isopropoxide, titanium chloride, tungsten chloride, and tungsten alkoxide may be added during the catalyst formation process. In one example, adding one or more of titanium, tungsten, and zirconium improves the interface between the catalyst and the substrate and/or support. These adhesives may provide structural integrity by fusing catalyst components to a conducting surface. Metal oxides may be utilized as metal-oxide-bonding may form to improve the interface. These adhesives may expand the types of surfaces that the catalyst may be added to, such as various metal oxides and graphitic surfaces.

As discussed, the one or more catalyst layers may include one or more active catalytic metals and a tantalum oxide (TaₓO_{y}) support. In one example, all layers of the one or more catalyst layers may include the same active catalytic metals and the tantalum oxide support. For example, the one or more catalyst layers may include two or more catalyst layers including the same active catalytic metals in each layer. In another example, all layers of the one or more catalyst layers may include the same secondary metal. In yet another example, the one or more catalyst layers include two or more catalyst layers, wherein at least two catalyst layers include at least one different active catalytic metal. In yet another example, the one or more catalyst layers include two or more catalyst layers, wherein at least two catalyst layers include at least one different secondary metal. In yet another example, the one or more catalyst layers include two or more catalyst layers, wherein at least two catalyst layers include at least one different adhesive. The one or more catalyst layers may all include the same weight ratio of active catalytic metals. The one or more catalyst layers may include two or more catalyst layers, wherein at least two catalyst layers include at least one active catalytic metal and/or secondary metal with a different weight ratio.

The catalyst may be in contact with a substrate. The substrate may include a conducting surface. In one example, the substrate includes one or more of titanium, nickel, stainless steel, lead, aluminum, and carbon. In another example, the substrate includes a conducting material selected from oxide-free titanium and oxide-free stainless steel. Oxide-free titanium and oxide-free stainless steel substrates may be cleaned by bath sonication and dried prior to catalyst addition. In yet another example, the catalyst is coated on conducting titanium, stainless steel, carbon paper, carbon cloth, and/or carbon felt. Carbon substrates may be acid-treated to improve hydrophilicity. In one example, the catalyst is coated on the substrate in one or more layers. For example, the catalyst may be coated 1 to 20 times on the substrate. In another example, the catalyst may be coated 2 to 10 times on the substrate. In yet another example, the catalyst may be coated 2 to 6 times on the substrate. Each coating layer may be dried and heated to improve stability and interface strength.

The total catalyst coating thickness may vary depending on the application and conditions. The total catalyst coating thickness may range from about 1 micrometer to about 20 micrometers. In one example, the total catalyst coating thickness may range from about 1 micrometer to about 15 micrometers. In another example, the total catalyst coating thickness may range from about 2 micrometers to about 10 micrometers. For example, the total catalyst coating thickness may range from about 2 micrometers to about 6 micrometers. The average total catalyst coating thickness may be about 2 micrometers, about 3 micrometers, about 4 micrometers, about 5 micrometers, and values therebetween. In addition or alternatively, catalyst nanoparticles may be utilized. For example, the diameter of catalyst nanoparticles may range from about 5 nm to about 500 nm.

Ink including the catalyst composition may be prepared and coated on the substrate. In one example, ink is a liquid at room temperature (about 20° C.) and atmospheric pressure. In another example, the ink is formed by mixing tantalum (V) ethoxide or tantalum chloride with ruthenium chloride. The amount of tantalum ethoxide or tantalum chloride may vary. Additionally, titanium compounds, tungsten compounds, and/or zirconium compounds may be added to the ink as an adhesive. For example, tantalum may be combined with titanium chlorides, titanium alkoxides, tungsten chlorides, tungsten alkoxides, and/or zirconium chloride. The amount of ruthenium may be varied, and a secondary metal of the present disclosure may be added. The ink/coating may be added to a substrate of the present disclosure. In one example, only the first layer coated of the one or more catalyst layers is in contact with the substrate. For example, the one or more catalyst layers may be coated on top of one another. In another example, more than one layer of the one or more catalyst layers is in contact with the substrate. For example, the one or more catalyst layers may be coated side by side so that two or more catalyst layers are in contact with the substrate.

The catalyst may be utilized in one or more cathodes and anodes for electrochemical water splitting. Importantly, the same catalyst composition may be utilized for both the cathode and the anode. Further, the cathode and the anode may include different substrates. The cathode and the anode may be placed in an alkaline or acidic solution. The catalyst may also be used for water treatment applications and heterogeneous catalysis. In one example, adding one or more of iridium chloride/cobalt chloride/nickel chloride/iron chloride/palladium chloride/platinum chloride/copper chloride or their other precursors (such as acetates, bromides, iodides) to the catalyst composition may enhance the lifetime of electrodes in alkaline or acidic conditions, enabling unique applications for the catalyst of the present disclosure. The current density may range from 10 mA/cm² to 1500 mA/cm². In one example, the current density may range from 10 mA/cm² to 200 mA/cm². In another example, the current density may range from 200 mA/cm² to 1300 mA/cm². In another example, the current density may range from 500 mA/cm² to 1000 mA/cm².

The catalyst may be utilized for hydrogen production in a process such as alkaline electrolysis or in acidic conditions such as PEM. For example, alkaline electrolysis typically operates in a liquid alkaline electrolyte solution. In one example, the liquid alkaline electrolyte solution includes one or more of potassium hydroxide, lithium hydroxide, sodium hydroxide, and water. For example, this base may have a molarity ranging from about 0.2 M to about 12 M. In another example, the base may have a molarity ranging from about 1 M to about 9 M. In yet another example, the base may have a molarity ranging from about 1 M to about 6 M. In yet another example, the electrolyte may include 10 wt. % to 40 wt. % of potassium hydroxide. The catalyst may be utilized in various acidic conditions. For example, the catalyst may be utilized in sulfuric acid, hydrochloric acid, phosphoric acid, perchloric acid, acetic acid, citric acid, nitric acid, and ammonium sulfate. In one example, the acid may include any acid with the sulfate anion. The acid may have a molarity ranging from about 0.2 M to about 18 M. In one example, the acid has a molarity ranging from about 0.5 M to 5 M. Accordingly, the catalysts may be used with an electrolyte such as a salt, an acid, or a base. The electrolyte may include water.

The electrodes in electrolysis process may be separated by a separator or diaphragm. The diaphragm may prevent short circuiting and/or mixing of the hydrogen and oxygen produced. This separator or diaphragm may be non-conductive. In another example, alkaline or acidic electrolysis is performed at moderate temperatures and pressures, such as at a temperature ranging from about 20° C. to 120° C., 50° C. to 100° C., or 70° C. to 100° C. The operating pressure during alkaline or acidic electrolysis may range from about 1 bar to about 40 bar. In another example, the operating pressure during alkaline or acidic electrolysis may range from about 2 bar to about 10 bar.

The catalyst may be stable for many hours during a water splitting process. In one example, the catalyst is stable and efficiently produces hydrogen for over 1000 hours. In another example, the catalyst is stable and efficiently produces hydrogen for 100 hours to 1500 hours. In yet another example, the catalyst is stable and efficiently produces hydrogen for 500 hours to 20000 hours. For example, the catalyst may be stable and may efficiently produce hydrogen for over 1000 hours at an applied current of 1,000 mA and a current density of 50 mA/cm². The overpotential (V) may decrease by less than 0.2 after 1000 hours of water splitting in an alkaline or acidic environment. In one example, the overpotential (V) may decrease by less than 0.1 after 1000 hours of water splitting in an alkaline or acidic environment. In another example, the overpotential (V) may decrease by less than 0.05 after 1000 hours of water splitting in an alkaline or acidic environment with a current density of 50 mA/cm².

Importantly, the catalyst of the present disclosure is highly stable in harsh chemical conditions, especially in electrochemical water splitting conditions. Further, the catalyst of the present disclosure be used on/in an anode and a cathode for electrochemical water splitting. The catalyst may have an enhanced activity and lifetime in alkaline or acidic conditions. This catalyst may be efficiently coated on a substrate for various applications and may be coated in one or more layers. By coating the catalyst on the substrate, a cathode may be formed under reducing conditions and an anode may be formed under oxidizing conditions.

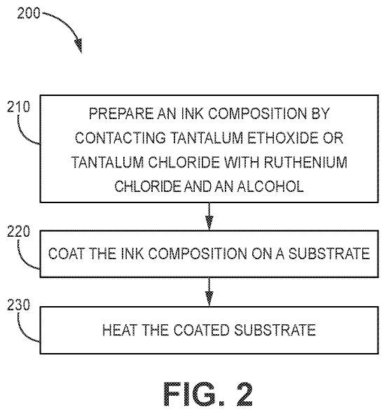

Referring to FIG. 2, a method 200 of making an electrode is illustrated. Method 200 includes one or more of the following steps:

STEP 210, PREPARE AN INK COMPOSITION BY CONTACTING TANTALUM ETHOXIDE OR TANTALUM CHLORIDE WITH RUTHENIUM

CHLORIDE AND AN ALCOHOL, includes preparing an ink composition by contacting tantalum ethoxide or tantalum chloride with ruthenium chloride and an alcohol such as n-butanol. Contacting may include mixing, stirring, placing two or more components in physical proximity, and/or heating. The mixture may be stirred until all solid materials are dissolved. Tantalum ethoxide or tantalum chloride may be utilized in various weight percentages in the ink composition. In one example, the tantalum ethoxide and/or tantalum chloride is present from 0.3 wt. % to 40 wt. % in the ink composition. In another example, the tantalum ethoxide or tantalum chloride is present from 1 wt. % to 30 wt. % in the ink composition. In yet another example, the tantalum ethoxide or tantalum chloride is present from 1 wt. % to 20 wt. % in the ink composition. Other tantalum containing compounds may be utilized such as other tantalum salts.

Ruthenium chloride may be utilized in various weight percentages in the ink composition. In one example, the weight percentage of ruthenium chloride in the ink composition ranges from about 0.05 wt. % to 50 wt. %. In another example, the weight percentage of ruthenium chloride in the ink composition ranges from about 0.1 wt. % to 40 wt. %. In yet another example, the weight percentage of ruthenium chloride in the ink composition ranges from about 1 wt. % to 30 wt. %. An acid, such as hydrochloric acid, may be added to the ink composition. For example, 0.1 mL to 1 mL of hydrochloric acid may be added to the ink composition per 100 mg of ruthenium chloride. In another example, 0.1 mL to 0.5 mL of hydrochloric acid may be added to the ink composition per 100 mg of ruthenium chloride. In yet another example, 0 mL to 10 mL of hydrochloric acid may be added to the ink composition.

One or more secondary metal compounds may be added to the ink composition. For example, one or more of iridium chloride, cobalt chloride, nickel chloride, iron chloride, palladium chloride, platinum chloride, copper chloride, or other respective precursors of each (such as acetates, bromide, iodides) may be added to the ink composition. The weight percentage of the secondary metal compound in the ink composition may range from 0.01 wt. % to 30 wt. %. In one example, the weight percentage of the secondary metal compound in the ink composition ranges from 0.05 wt. % to 20 wt. %. In another example, the weight percentage of the secondary metal compound in the ink composition ranges from 1 wt. % to 10 wt. %. In yet another example, the weight percentage of the secondary metal compound in the ink composition ranges from 3 wt. % to 15 wt. %.

An adhesive, such as a titanium salt, may be added to the ink composition. In one example, one or more of titanium n-butoxide, titanium isopropoxide, titanium chloride, tungsten chloride, tungsten alkoxide, and zirconium chloride may be added to the ink composition as an adhesive. In one example, the weight percentage of the adhesive in the ink composition ranges from 0.1 wt. % to 90 wt. %. In another example, the weight percentage of the adhesive in the ink composition ranges from 0.5 wt. % to 70 wt. %. In yet another example, the weight percentage of the adhesive in the ink composition ranges from 1 wt. % to 50 wt. %. For example, the weight percentage of the adhesive in the ink composition may range from about 1 wt. % to about 20 wt. %, from about 20 wt. % to about 35 wt. %, or about 35 wt. % to about 50 wt. %. For example, the weight percentage of the adhesive in the ink composition may range from 1 wt. % to 10 wt. %. The adhesive may improve the adhesion and/or interface between the catalyst and the substrate. Further, the adhesive may prevent the catalyst from peeling away from the substrate. By improving the adhesion, the stability of the catalyst/electrode may be improved.

Various alcohols may be utilized in the ink preparation process. The alcohol may include one or more of n-butanol, ethanol, and isopropanol. In one example, both n-butanol and isopropanol are utilized. In another example, the volume ratio of n-butanol to isopropanol ranges from about 2:1 to about 5:1. In yet another example, the volume ratio of n-butanol to isopropanol ranges from about 2:1 to about 4:1. The volume of n-butanol and isopropanol may be adjusted, and these alcohols may be replaced with other alcohols. In one non-limiting example, 5 mL to 50 mL of n-butanol and 1 mL to 20 mL of isopropanol may be added to the ink composition. In one example, 10 mL to 30 mL of n-butanol may be added per 100 mg of ruthenium chloride. In another example, 5 mL to 20 mL of isopropanol may be added per 100 mg of ruthenium chloride.

STEP 220, COAT THE INK COMPOSITION ON A SUBSTRATE, includes coating the ink composition on a substrate such as titanium. In one example, the substrate includes one or more of titanium, nickel, stainless steel, lead, aluminum, and carbon. In another example, the substrate includes a conducting material such as oxide-free titanium and oxide-free stainless steel. Oxide-free titanium and oxide-free stainless steel substrates may be cleaned by bath sonication and dried prior to catalyst addition. Isopropyl alcohol and acetone may be used for bath sonication. In yet another example, the catalyst is coated on conducting titanium, stainless steel, carbon paper, carbon cloth, and/or carbon felt. Carbon substrates may be acid-treated to improve hydrophilicity.

The ink composition may be coated on the substrate by brush painting, dip coating, drop casting, screen printing, spray coating, and spin coating. For example, brush coating may be utilized for removing the uncoated area with brushing and making it more durable. In one example, the ink composition is coated on the substrate in one or more layers and may be coated one or more times on the substrate. For example, the ink composition may be coated 1 to 20 times on the substrate. In another example, the ink composition may be coated 2 to 10 times on the substrate. For example, the ink composition may be coated 2 times, 3 times, 4 times, 5 times, 6 times, 7 times, 8 times, 9 times, or 10 times on the substrate. In yet another example, the ink composition may be coated 2 to 6 times on the substrate. The substrate may be dried and heated/annealed at a temperature ranging from 250° C. to 500° C. between each coating. For example, the substrate may be dried and heated/annealed at a temperature ranging from 300° C. to 420° C. between each coating. Drying and annealing may ensure that the surface includes a stable layer of active materials on the surface.

STEP 230, HEAT THE COATED SUBSTRATE, includes heating the coated substrate, such as the substrate including one or more of titanium, nickel, stainless steel, lead, aluminum, and carbon. In one example, a cathode electrode may be produced by method 200. In another example, an anode electrode may be produced by method 200. The heat treatment of the coated substrate may vary depending on the particular application, such as for a cathode and for an anode.

Heating the coated substrate may include a heat treatment of the coated substrate. In one example, the coated substrate is heated to/at a temperature ranging from 200° C. to 700° C. In another example, the coated substrate is heated to/at a temperature ranging from 250° C. to 600° C. In yet another example, the coated substrate is heated to/at a temperature ranging from 300° C. to 550° C. For example, the coated substrate may be heated to/at a temperature ranging from 300° C. to 480° C. The coated substrate may be heated to/at a temperature above 300° C. For example, the coated substrate may be heated to/at a temperature of about 301° C., about 325° C., about 350° C., about 375° C., about 400° C., about 425° C., about 450° C., about 475° C., about 500° C., about 525° C., about 550° C., and values therebetween. The coated substrate may be heated to/at a temperature of about 400° C.

Heating the coated substrate may include heating under a reducing condition. For example, heating the coated substrate may include heating sufficient to prepare the metallic form of ruthenium, as this form may be more active for HER. In one example, heating under a reducing condition includes heating to/at a temperature ranging from 300° C. to 550° C. in argon, nitrogen, and/or hydrogen atmosphere. For example, the coated substrate may be heated in a mixture of hydrogen and argon. Heating the coated substrate may include heating under an oxidizing condition. For example, heating the coated substrate may include heating sufficient to prepare the oxide form of ruthenium, as the oxide form may perform better for OER. In one example, heating under an oxidizing condition includes heating to/at a temperature ranging from 300° C. to 480° C. in gas atmosphere. For example, the oxidizing condition may include heating the coated substrate in air. While method 200 illustrates one embodiment of making the electrode, alternatively, tantalum oxide nanoparticles may be formed, and the ruthenium may be deposited through wet impregnation. Following the wet impregnation, the electrode preparation may follow one or more steps of method 200.

Importantly, coating the substrate with the ink composition is sufficient to form a stable layer of active materials on the substrate. Coating may include brush painting, dip coating, drop casting, screen printing, and spin coating. The coating methods of the present disclosure improve electrode stability and prevent catalyst layer peeling. Further, the formed electrode may be tuned according to the desired application. For example, the coated substrate may be placed in an oxidizing atmosphere or a reducing atmosphere to form a cathode and an anode from the same catalyst composition. Additionally, the amount of catalyst in the ink may be varied to tune the electrode for different alkaline or acidic conditions and for different charge densities. Therefore, the coating method provides an efficient method for producing a tuned electrode for a particular application, such as for an anode and cathode.

An electrochemical water splitting system may include system 100 and/or may include one or more of a reservoir, an electrical energy source, a cathode, an anode, a membrane, a diaphragm, and an electrolyte. The electrical energy source may be a power supply. The electrical energy source may be photovoltaic cells, hydropower, and wind turbines. The electrolyte may be retained in the reservoir and may be in contact with the cathode and the anode. The reservoir may be a tank, tube, or piping sufficient for holding, storing, and/or placing the electrolyte in contact with the anode and cathode. Retaining may include holding the electrolyte in place or position. The electrolyte may be in a movable condition, such as flowing past the cathode and the anode. The electrolyte may be alkaline, neutral pH, or acidic. The electrochemical water splitting system may include a catalyst and substrate of the present disclosure and may be utilized for alkaline or acidic conditions. The catalyst and substrate of the present disclosure may form the electrodes (cathode and/or the anode). The anode is sufficient for the OER and the cathode is sufficient for the HER.

As electrical energy is introduced from the electrical energy source (connected to one or more of the cathode and the anode), hydrogen gas is produced at the anode and oxygen gas is produced at the cathode. Therefore, the electrical energy source may drive the reaction and may drive the flow of electrons. This electron flow may not occur without the electrical energy source. Applying the voltage from the electrical energy source may be sufficient to overcome a negative potential of the system and drive the production of hydrogen. Hydrogen production may be utilized for hydrogen containing or requiring devices such as fuel cells. Further, hydrogen production may be utilized for engines and cars. Additionally, the electrodes may be utilized for water treatment and/or cleaning for water disinfection.

The electrode(s) of the present disclosure and/or the electrochemical water splitting system (such as system 100) may be sufficient for alkaline water electrolysis (AWE). The AWE system may include one or more of an electrical energy source (such as electrical energy source 120), a cathode (such as cathode 130), an anode (such as anode 140), an electrolyte (such as electrolyte 150), and a reservoir (such as reservoir 110). Alkaline conditions may provide a wide range of applications. In one example, alkaline water electrolysis utilizes two electrodes in a liquid alkaline electrolyte. The liquid alkaline electrolyte may include an alkali, such as hydroxides of lithium, sodium, potassium, rubidium, and cesium. In one example, the liquid alkaline electrolyte solution includes one or more of potassium hydroxide, lithium hydroxide, sodium hydroxide, and water. For example, this base may have a molarity ranging from about 0.2 M to about 12 M. In another example, the base may have a molarity ranging from about 1 M to about 9 M. In yet another example, the base may have a molarity ranging from about 1 M to about 6 M.

The alkaline electrolyte may have a pH greater than 7. The alkaline electrolyte may be combined with water to alter the pH. In one example, the pH of the alkaline electrolyte ranges from about 7 to about 14. In another example, the pH of the alkaline electrolyte ranges from about 8 to about 12. In yet another example, the pH of the alkaline electrolyte ranges from about 10 to about 14. AWE may be performed at moderate temperatures and pressures, such as at a temperature ranging from about 20° C. to 120° C., 50° C. to 100° C., or 70° C. to 100° C. The operating pressure during AWE may range from about 1 bar to about 40 bar. In another example, the operating pressure during AWE may range from about 2 bar to about 10 bar. The AWE system may utilize the catalysts of the present disclosure for one or more of the cathode and the anode, sufficient to produce hydrogen from water. Importantly, efficient water splitting in alkaline conditions may improve the feasibility and efficiency of large-scale water splitting applications.

The electrode(s) of the present disclosure and/or system 100 may be utilized for anion exchange membrane (AEM) electrolysis. AEM is a type of electrolysis technology working in pH ranges greater than or equal to 7, such as alkaline conditions using a membrane. The AEM system may include one or more of an electrical energy source (such as electrical energy source 120), a cathode (such as cathode 130), an anode (such as anode 140), an electrolyte (such as electrolyte 150), and a membrane. The membrane may be a separating membrane between the cathode and the anode. The membrane may allow negatively charged ions to pass through. For example, negatively charged OH ions may pass through the membrane from the cathode side to the anode side. The AEM system may utilize pure water and/or alkaline conditions. In one example, the liquid alkaline electrolyte solution includes one or more of potassium hydroxide, lithium hydroxide, sodium hydroxide, and water. For example, this base may have a molarity ranging from about 0.1 M to about 12 M. In another example, the base may have a molarity ranging from about 0.1 M to about 6 M. In yet another example, the base may have a molarity ranging from about 0.5 M to about 2 M.

The alkaline electrolyte may have a pH greater than 7. The alkaline electrolyte may be combined with water to alter the pH. In one example, the pH of the alkaline electrolyte ranges from about 7 to about 14. In another example, the pH of the alkaline electrolyte ranges from about 8 to about 12. In yet another example, the pH of the alkaline electrolyte ranges from about 10 to about 14. In one example, AEM may be operated at temperatures less than 100° C. In another example, AEM may be operated at temperatures less than 80° C. AEM may be performed at moderate temperatures and pressures, such as at a temperature ranging from about 20° C. to 120° C., 50° C. to 100° C., or 70° C. to 100° C. The operating pressure during AEM may range from about 1 bar to about 40 bar. In another example, the operating pressure during AEM may range from about 2 bar to about 10 bar. The AEM system may utilize the catalysts of the present disclosure for one or more of the cathode and the anode, sufficient to produce hydrogen from water.

The electrode(s) of the present disclosure and/or the electrochemical water splitting system (such as system 100) may be sufficient for acidic conditions. The water splitting system may be operated in an acidic solution/electrolyte, such as a solution of sulfuric acid. For example, sulfuric acid may be 0.5 M sulfuric acid. The acidic condition may include one or more of hydrochloric acid, phosphoric acid, perchloric acid, acetic acid, citric acid, nitric acid, and ammonium sulfate. The electrochemical water splitting system may be operated in a liquid with a pH ranging from 0 to about 7. In one example, the liquid may have a pH ranging from about 2 to about 7. The liquid may have a pH of less than 7, less than 6, less than 5, or less than 4. In another example, the liquid may have a pH ranging from about 3 to about 6. Accordingly, system 100 may be utilized at various pH ranges from acidic to basic conditions (0 to 14 pH). The electrode of the present disclosure and/or the electrochemical water splitting system (such as system 100) may be sufficient for PEM. In a PEM-based electrolysis cell, water splitting is performed under acidic conditions (such as the pH of the present paragraph) using the proton exchange membrane, sufficient to produce hydrogen from water. The PEM system may include one or more of an electrical energy source (such as electrical energy source 120), a cathode (such as cathode 130), an anode (such as anode 140), an electrolyte (such as electrolyte 150), and a membrane. The membrane may be a polymer membrane and/or may separate the cathode and the anode. The membrane may be a solid polymer electrolyte. Protons may be transported across the membrane to be reduced to hydrogen. In one example, the operating temperature for PEM ranges from about 20° C. to about 120° C. The PEM system may utilize the catalysts of the present disclosure for one or more of the cathode and the anode.

The electrode(s) of the present disclosure and/or the electrochemical water splitting system (such as system 100) may be sufficient for SOEC. The SOEC system may include one or more of an electrical energy source (such as electrical energy source 120), a cathode (such as cathode 130), an anode (such as anode 140), and an electrolyte (such as electrolyte 150). Oxygen ions may be drawn through the electrolyte. The SOEC system may utilize a solid oxide or ceramic electrolyte. SOEC can produce hydrogen from electricity and water. In one example, SOEC uses high temperature steam to form hydrogen and oxygen. In another example, steam at a temperature ranging from 500° C. to 1000° C. is utilized. In yet another example, the SOEC operates at a temperature ranging from about 600° C. to about 900° C. In yet another example, high temperatures may be utilized to facilitate electrochemical reactions. The SOEC system may utilize the catalysts of the present disclosure for one or more of the cathode and the anode.

Electrode(s) for the electrochemical water splitting system (such as system 100 for AWE, AEM, PEM, and SOEC) may include the catalysts of the present disclosure and a substrate. These electrodes may include one or more catalyst layers including one or more active catalytic metals and a tantalum oxide (TaₓO_{y}) support, and a substrate. The one or more catalyst layers may be in contact with a substrate. In one example, the anode includes one or more catalyst layers including one or more active catalytic metals and a tantalum oxide support. The anode may include one or more of the secondary metals of the present disclosure. For example, the secondary metals may assist in improving performance and stability for the anode. In another example, the cathode includes one or more catalyst layers including one or more active catalytic metals and a tantalum oxide support. The cathode may include one or more of the secondary metals secondary metals of the present disclosure. For example, the secondary metals may assist in improving performance and stability for the cathode. The anode and the cathode may include the same active catalytic metals. The anode and the cathode may include the same or different catalyst composition. The anode and the cathode may include the same or different substrate.

In one example, the electrode includes a catalyst including one or more catalyst layers including ruthenium, platinum, or iridium, and a tantalum oxide support. In another example, the weight percentage of ruthenium in the catalyst ranges from about 1 wt. % to about 50 wt. %. In yet another example, the weight percentage of ruthenium in the catalyst ranges from about 1 wt. % to about 40 wt. %. In yet another example, the weight percentage of ruthenium in the catalyst ranges from about 1 wt. % to about 30 wt. %. For example, the weight percentage of ruthenium in the catalyst may range from about 1 wt. % to about 10 wt. %, or from about 10 wt. % to about 20 wt. %, or from about 20 wt. % to about 30 wt. %. For example, the weight percentage of ruthenium in the catalyst may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, and values therebetween. For example, the weight percentage of ruthenium in the catalyst may be about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, and values therebetween. The weight percentage of ruthenium in the catalyst may be less than 30 wt. %.

The secondary metal may include one or more of iridium, cobalt, nickel, iron, palladium, platinum, copper, and molybdenum. In one example, adding a secondary metal to the catalyst may enhance the activity of the catalyst and may enhance the lifetime of an electrode in alkaline or acidic conditions. In another example, adding a secondary metal to the catalyst may enhance the OER and/or the HER. In one example, the weight percentage of the secondary metal(s) in the catalyst may range from about 0.01 wt. % to about 30 wt. %. In another example, the weight percentage of the secondary metal(s) in the catalyst may range from about 0.01 wt. % to about 15 wt. %. In yet another example, the weight percentage of the secondary metal(s) in the catalyst may range from about 0.01 wt. % to about 10 wt. %. For example, the weight percentage of the secondary metal(s) in the catalyst may range from about 0.1 wt. % to about 10 wt. %. For example, the weight percentage of the secondary metal(s) in the catalyst may be about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, and values therebetween. The weight percentage of the secondary metal(s) in the catalyst may be less than about 10 wt. %. In one example, a secondary metal with a weight percentage in the catalyst of about 0.1 wt. % to 10 wt. % increases the performance for one or more of the HER and the OER.

The support may include tantalum oxide (TaₓO_{y}). While metals such as ruthenium may act as an active catalytic metal, the tantalum oxide may be utilized for improved catalyst stability and for promoting activity. In one example, the tantalum oxide support includes tantalum pentoxide, including the formula Ta₂O₅. In one example, the weight percentage of tantalum oxide in the catalyst ranges from 20 wt. % to 99 wt. %. In another example, the weight percentage of tantalum oxide in the catalyst ranges from 30 wt. % to 95 wt. %. In yet another example, the weight percentage of tantalum oxide in the catalyst ranges from 40 wt. % to 80 wt. %. For example, the weight percentage of tantalum oxide in the catalyst may range from 40 wt. % to 60 wt. %, from 50 wt. % to 70 wt. %, or from 60 wt. % to 80 wt. %. The weight percentage of tantalum oxide in the catalyst may be greater than 50%. The weight percentage of tantalum oxide in the catalyst may be greater than 60%. The weight percentage of tantalum oxide in the catalyst may be greater than 70%.

The one or more catalyst layers may include one or more metals such as titanium, tungsten, and zirconium. The catalyst may be in contact with the substrate. The substrate may include a conducting surface. In one example, the substrate includes one or more of titanium, nickel, stainless steel, lead, aluminum, and carbon. In another example, the substrate includes a conducting material selected from oxide-free titanium and oxide-free stainless steel. Oxide-free titanium and oxide-free stainless steel substrates may be cleaned by bath sonication and dried prior to catalyst addition. In yet another example, the catalyst is coated on conducting titanium, stainless steel, carbon paper, carbon cloth, and/or carbon felt. Carbon substrates may be acid-treated to improve hydrophilicity. In one example, the catalyst is coated on the substrate in one or more layers. For example, the catalyst may be coated 1 to 20 times on the substrate. In another example, the catalyst may be coated 2 to 10 times on the substrate. In yet another example, the catalyst may be coated 2 to 6 times on the substrate. Each coating layer may be dried and heated to improve stability and interface strength.

In one example, the electrolyte may include one or more of potassium hydroxide, sodium hydroxide, and water. The electrolyte may include any electrolyte sufficient for alkaline electrolysis. For example, the electrolyte may have a molarity ranging from about 1 M to about 12 M. In another example, the electrolyte may include potassium hydroxide with a molarity ranging from about 1 M to about 4 M. The electrodes in an electrochemical water splitting system may be separated by a separator or diaphragm. The diaphragm may prevent short circuiting and/or mixing of the hydrogen and oxygen produced. This separator or diaphragm may be non-conductive.

As electrical energy is introduced from the electrical energy source to the electrode, hydrogen gas may be produced at the anode and oxygen gas may be produced at the cathode. The voltage and current from the electrical energy source may vary. The voltage and current from the electrical energy source may be sufficient to produce hydrogen at the anode. The current density in the electrolyte may range from 10 mA/cm² to 1500 mA/cm². In one example, the current density in the electrolyte may range from 10 mA/cm² to 200 mA/cm². In another example, the current density in the electrolyte may range from 200 mA/cm² to 1300 mA/cm². In another example, the current density in the electrolyte may range from 500 mA/cm² to 1000 mA/cm².

Conventionally, electrocatalysis has been the major bottleneck for efficient electrochemical water splitting. Further, conventional OER catalysts in acidic media required noble metal catalysts. Importantly, the electrochemical water splitting system (such as system 100) is lower cost and efficient for producing hydrogen using electrodes in an alkaline or acidic media and using membranes. Efficiency and stability are important for achieving the desired electrocatalytic hydrogen production from water. Without proper stability and activity, electrocatalysis may be inefficient and unstable. The electrochemical water splitting system utilizes the stable catalyst of the present disclosure to produce hydrogen at the anode, and the catalyst is stable for thousands of hours (or more). Compared to conventional electrodes, the present electrodes are efficient and stable for long-run times in the electrolyte (0-14 pH). Since the cathode and the anode may be made from an ink preparation process, the compositions of both the cathode and the anode may be tuned to benefit HER and OER. Further, the electrochemical water splitting system may be used in hydrogen containing devices and in cars, ships, and desalination applications.

### Example 1

Ruthenium tantalum oxide (Ta-R) ink was prepared by mixing 0.3 g (0.88 mmol) of tantalum (V) ethoxide or tantalum chloride (0.3 g; 0.88 mmol), RuCl₃ (70 mg; 0.34 mmol), titanium n-butoxide (adhesive, 5 g; 14.5 mmol), and HCl (0.1 mL). These components were dissolved in n-butanol (15 mL) and isopropanol (5 mL) mixture. The mixture was stirred until all the solid materials were dissolved.

Ruthenium-iron-tantalum oxide (Ta-RF) ink was prepared by mixing 0.3 (0.88 mmol) of tantalum (V) ethoxide or tantalum chloride (0.3 g; 0.88 mmol), RuCl₃ (70 mg; 0.34 mmol), FeCl₂ (0.3 g), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

Ruthenium-cobalt-tantalum oxide (Ta-RC) ink was prepared by mixing 0.3 (0.88 mmol) of tantalum (V) ethoxide or tantalum chloride (0.3 g; 0.88 mmol), RuCl₃ (70 mg; 0.34 mmol), CoCl₂ (0.3 g), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

Ruthenium-iridium-tantalum oxide (Ta-RI) ink was prepared by mixing 1 g of tantalum (V) ethoxide or tantalum chloride (0.88 g; 2.46 mmol), RuCl₃ (70 mg; 0.34 mmol), IrCl₃ (0.1 g), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

Ruthenium-iridium-tantalum oxide (L-Ta-RI) ink was prepared by mixing 0.3 (0.88 mmol) of tantalum (V) ethoxide or tantalum chloride (0.3 g; 0.88 mmol), RuCl₃ (70 mg; 0.34 mmol), IrCl₃ (0.1 g), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

Ruthenium iridium (RI) ink was prepared by mixing RuCl₃ (70 mg; 0.34 mmol), IrCl₃ (0.1 g), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

Ruthenium (R) ink was prepared by mixing RuCl₃ (70 mg; 0.34 mmol), titanium n-butoxide (adhesive, 5 g; 14.5 mmol), and HCl (0.1 mL). These components were dissolved in n-butanol (15 mL) and isopropanol (5 mL) mixture. The mixture was stirred till all the solid materials were dissolved.

In one example, tantalum ethoxide or tantalum chloride can range from 0.3-20 wt. %. tantalum can be combined with titanium or tungsten chlorides, alkoxides, or zirconium chloride. In another example, the amount of Ru can be varied from 1-30 wt. % in the catalyst. Other metals can also be used individually or as a secondary metal/co-catalyst (Ir, Pt, Pd, Co, Ni, Fe, Cu, Mo). The adhesive, titanium n-butoxide, can be in the range of 1 wt. % to 90 wt. %. Titanium n-butoxide can be replaced with other titanium alkoxides and chlorides. In yet another example, the amount of HCl can be varied from 0 mL to 10 mL, and the amount of n-butanol can be varied from 5 mL to 50 mL and replaced with other alcohols. The isopropanol can be varied from 1 mL to 20 mL and can also be replaced with other alcohols.

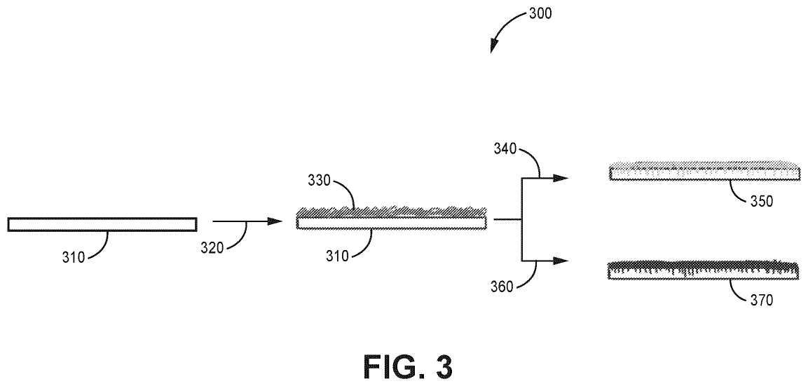

FIG. 3 illustrates an example method 300 of making an electrode, according to some embodiments. Method 300 may include utilizing a substrate 310 and catalyst ink 330 sufficient to make a cathode 350 and/or an anode 370. The substrate 310 may be a conducting metal plate, foam, or carbon. The substrate 310 may be conducting titanium (Ti), stainless steel (SUS), carbon paper, carbon cloth, and/or carbon. Oxide-free titanium and stainless steel (SUS) plates may be cleaned by bath sonication in isopropyl alcohol and acetone and dried in a vacuum oven. Carbon substrates may be acid-treated for better hydrophilicity. A coating process 320 may be utilized to coat the catalyst ink 330 on the substrate 310.

Coating process 320 may include brush painting, dip coating, drop-casting, screen printing, and spin coating. The coating process 320 can be varied according to the desired application. In one example, the catalyst ink 330 may be coated 1-20 times on the substrate 310 during the coating process 320. In another example, the catalyst ink 330 may be coated 1-8 times on the substrate 310 during the coating process 320. After each coating, the electrode substrate may be dried and annealed at 300° C. to 420° C. and maintained for 5-15 minutes, to ensure a stable layer of active materials on the surface. A reducing process 340 may be utilized to form the cathode 350. In one example, the reducing process 340 includes a 300° C. to 550° C. heat treatment under a reducing condition. The reducing condition may include one or more of argon, nitrogen, or 5% H₂/Ar. An oxidizing process 360 may be utilized to form anode 370. In one example, the oxidizing process 360 includes a 300° C. to 480° C. heat treatment under an oxidizing condition, such as in air atmosphere.

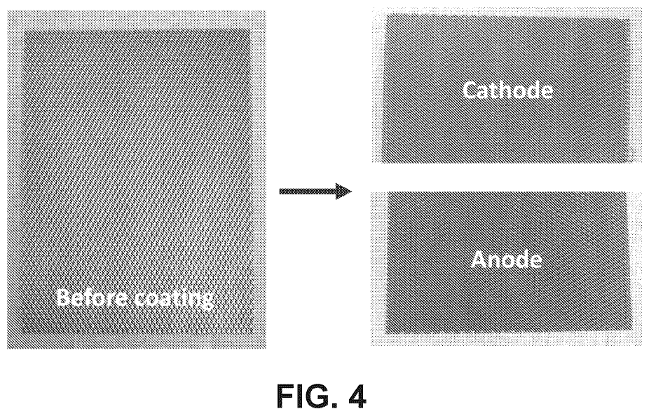

FIG. 4 illustrates the application of catalyst ink on the conducting surface, according to some embodiments. While FIG. 4 illustrates a titanium mesh, other conducting surfaces may be sufficient. For HER, since the metallic form of Ru is more active and to get more metallic Ru on the surface, the coated electrode obtained from the above procedure was annealed at 300-550° C. under a hydrogen atmosphere for 3 hours in a furnace (4% H₂/Ar mixture at a positive pressure of 4-5 bar). After cooling down to room temperature, the electrodes were taken out and rinsed to remove any suspended particles and tested for HER catalysis. For OER, since the oxide form of Ru may be preferred for catalysis and to obtain active metallic oxide on the surface, the coated electrode was annealed at 300-475° C. for 3 h in an air atmosphere in a furnace. After cooling down to room temperature, the electrodes were tested for OER.

### Example 2

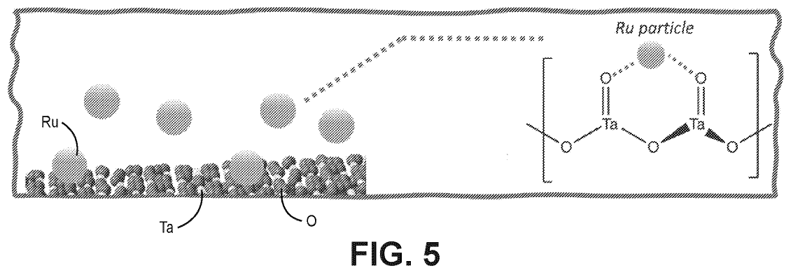

FIG. 5 illustrates an example of electrode materials including tantalum oxide supported ruthenium nanoparticles, according to some embodiments. An example of the structure of the tantalum oxide supported ruthenium nanoparticles is shown in FIG. 5. The electrode materials may be utilized for overall water splitting. Importantly, the electrode materials may be used as both a cathode and an anode. These electrode materials may be tuned by oxidation and reduction depending on the desired application.

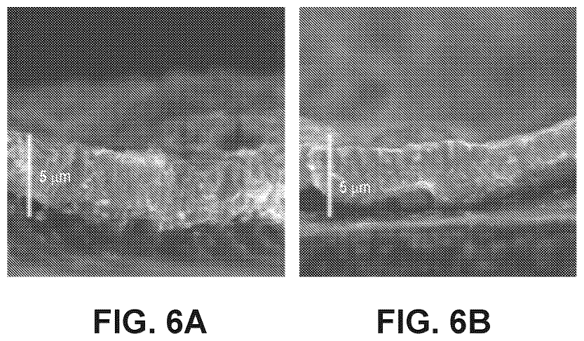

FIG. 6A illustrates a scanning electron microscopy (SEM) image of coating layer thickness, according to some embodiments. FIG. 6B illustrates a SEM image of coating layer thickness, according to some embodiments. The SEM images of coating layer thickness were completed at HV 10.0 kV, current 0.44 nA, mag 15000×. A cross-sectional image was taken by peeling off the coating layer after 6 brush coats. As shown, the coating layer thickness was in the range of about 2 micrometers to 5 micrometers. In one example, the total coating layer thickness averaged about 3 micrometers. On average, the thickness of each individual coating layer was about 0.5 micrometers each. The thickness of each individual coating layer may depend on the concentration of the catalyst in the ink.

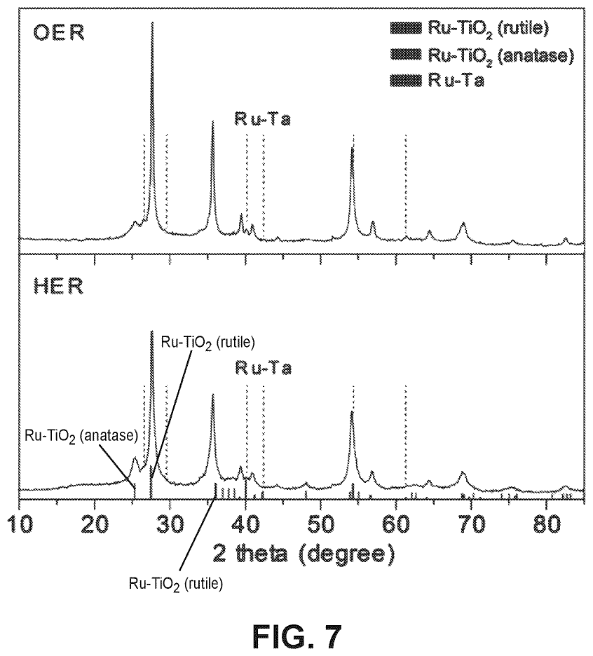

FIG. 7 illustrates XRD analysis of the ruthenium catalyst on tantalum and titanium oxide, according to some embodiments. The cathode was heat-treated under inert conditions and the anode was treated in air conditions. Ru-Ta is shown as the dashed lines in FIG. 7, and RuTiO₂ is shown as solid vertical bars/lines. As stated, the electrode for the cathode may be tuned for the HER. For example, heating the coated substrate may include heating sufficient to prepare the metallic form of ruthenium, as this form may be more active for HER. In one example, heating under a reducing condition includes heating to/at a temperature ranging from 300° C. to 550° C. in argon, nitrogen, and/or hydrogen atmosphere. For example, the coated substrate may be heated in a mixture of hydrogen and argon. The electrode for the anode may be tuned for OER. Heating the coated substrate may include heating under an oxidizing condition. For example, heating the coated substrate may include heating sufficient to prepare the oxide form of ruthenium, as the oxide form may perform better for OER. In one example, heating under an oxidizing condition includes heating to/at a temperature ranging from 300° C. to 480° C. in gas atmosphere. For example, the oxidizing condition may include heating the coated substrate in air.

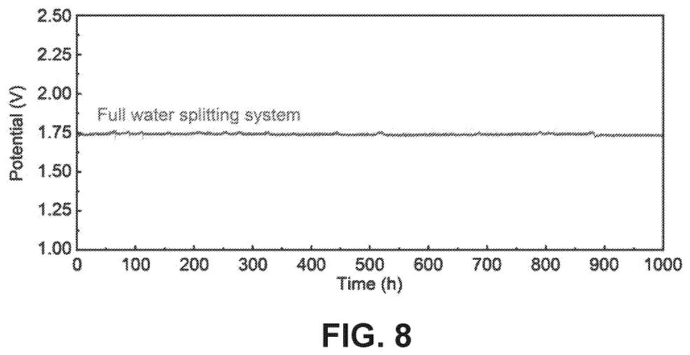

FIG. 8 illustrates a full water splitting (HER+OER) electrodes 1000 hour stability test result at 40 mA/cm² current density in alkaline conditions, according to some embodiments. The electrode size was 5 cm by 4 cm. The applied current was set at 1,000 mA. The current density was 40 mA/cm². The tantalum oxide-supported Ru catalyst shows excellent performance and stability compared to traditional catalysts. The tested conditions are far harsher than conventional methods (showing even stronger data) and meet quite challenging industrial standards. The electrolyte is alkaline, providing a wide range of applications.

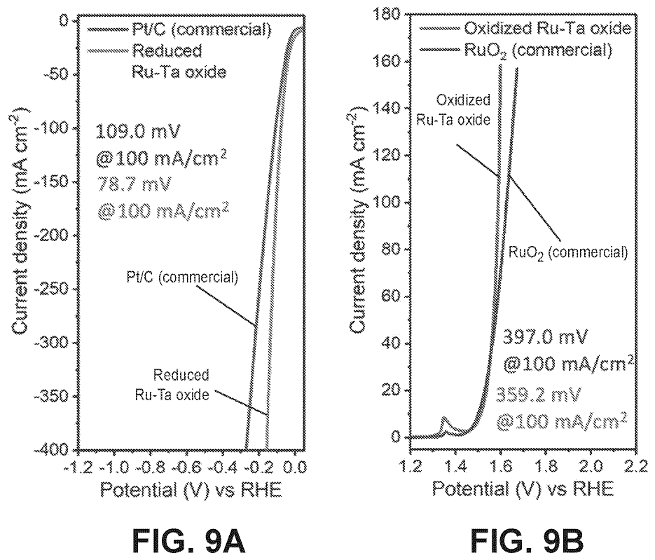

FIG. 9A illustrates HER performance (in alkaline conditions) including iR-corrected polarization curves of catalyst on tantalum oxide, Pt/C (20 Pt wt. %), and pure RuO₂, according to some embodiments. FIG. 9B illustrates OER performance (in alkaline conditions) including iR-corrected polarization curves of catalyst on tantalum oxide, and pure RuO₂, according to some embodiments. The electrochemical tests were performed on a potentiostat using a standard three-electrode system. All electrochemical tests were measured in an alkaline solution of 1 M KOH. The saturated calomel electrode (SCE) was used as a reference and the platinum wire as a working electrode. The polarization curves were performed at a scan rate of 5 mV s⁻¹. All potential values were converted to the reversible hydrogen electrode (RHE).

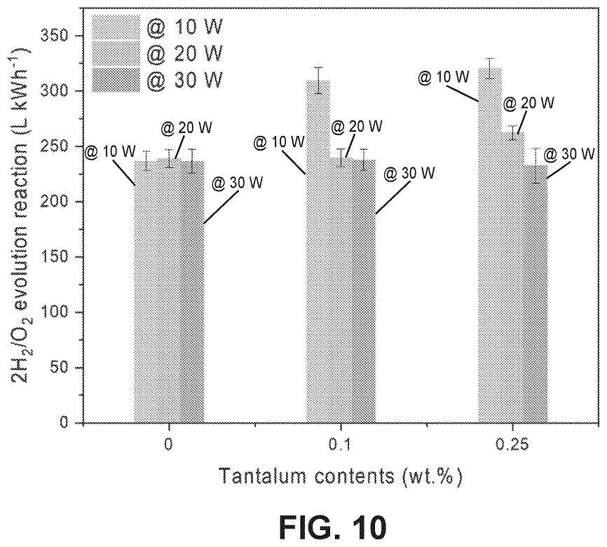

FIG. 10 illustrates the effect of tantalum on the catalyst electrode in alkaline conditions, according to some embodiments. With increasing power consumption (Watt, W), the amount of gas evolution decreases because of heat loss. It can be seen that as the tantalum content increases, the catalytic activity is excellent in the lower power region. In addition, when tantalum was added to the ink, the catalyst coating layer was stably on the electrode surface. The metal plate was stainless steel and the reaction included 1.0 M KOH solution at 24° C. The catalyst ink was prepared according to Example 1 preparation methods on a 100 mL scale. The amount of tantalum (V) ethoxide was controlled as 0, 0.88, and 2.2 g. Tantalum oxide doesn't have catalytic activity itself, but with active metals (such as Ru, Pt, and Ir), it shows improved catalytic activity. In addition, tantalum oxide is chemically inert, so it's a very stable oxide compared to other metal oxides. Therefore, the tantalum oxide can improve the catalytic activity and stability of water splitting electrode.

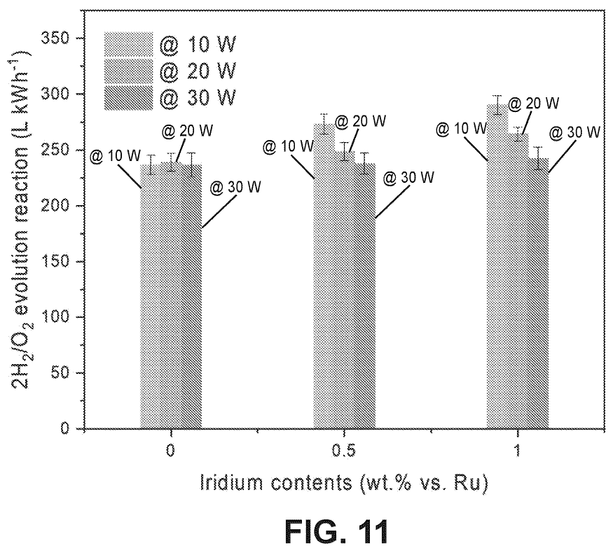

FIG. 11 illustrates the effect of bimetallic composition performance on the catalyst electrode in alkaline conditions, according to some embodiments. The metal plate was stainless steel, and the reaction included a 1.0 M KOH solution at 24° C. The catalyst ink was prepared according to Example 1 preparation methods on a 100 mL scale. The amount of iridium chloride was controlled as 0, 14, and 28 mg. As shown in FIG. 11, the catalytic performance improved with the addition of iridium chloride. This improvement is illustrated for 10 W, 20 W, and 30 W. This shows that the addition of iridium to the catalyst composition is sufficient to improve the performance of the electrode.

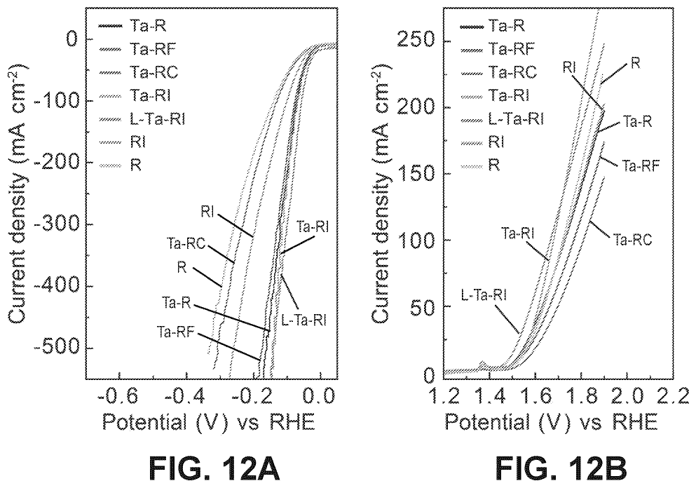

FIG. 12A illustrates the effect of different bimetallic compositions on the performance of the catalyst electrode (in alkaline conditions) with a current density ranging from about −500 mA cm⁻² to about 0 mA cm⁻², according to some embodiments. FIG. 12B illustrates the effect of different bimetallic compositions on the performance of the catalyst electrode (in alkaline conditions) with a current density ranging from about 0 mA cm⁻² to about 275 mA cm⁻², according to some embodiments. As illustrated the potential may be increased by adding a secondary metal to the catalyst composition. Generally, as the current density increases, the potential also increases. In one non-limiting example, the secondary metal can reduce the total overpotential for producing hydrogen. Therefore, the addition of the secondary metal may improve the overall catalytic activity, stability, and/or efficiency.

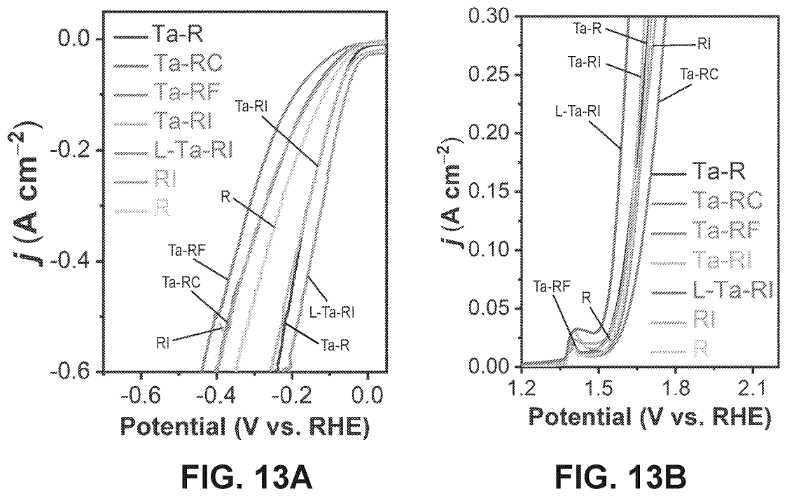

FIG. 13A illustrates the effect of different bimetallic compositions on the HER performance of the catalyst electrode in acidic conditions, according to some embodiments. As shown in this activity test, the Potential (V vs. RHE) scanning ranges from about 0 to −0.45. This HER activity was tested using a 0.5 M sulfuric acid solution. The current density (j, A cm 2) value ranges from about −0.6 to 0. FIG. 13B illustrates the effect of different bimetallic compositions on the OER performance of the catalyst electrode in acidic conditions, according to some embodiments. As shown in this activity test, the Potential (V vs. RHE) scanning ranges from about 0 to about 1.8. This OER activity was tested using a 0.5 M sulfuric acid solution. The j (A cm⁻²) value ranges from about 0.00 to about 0.30.

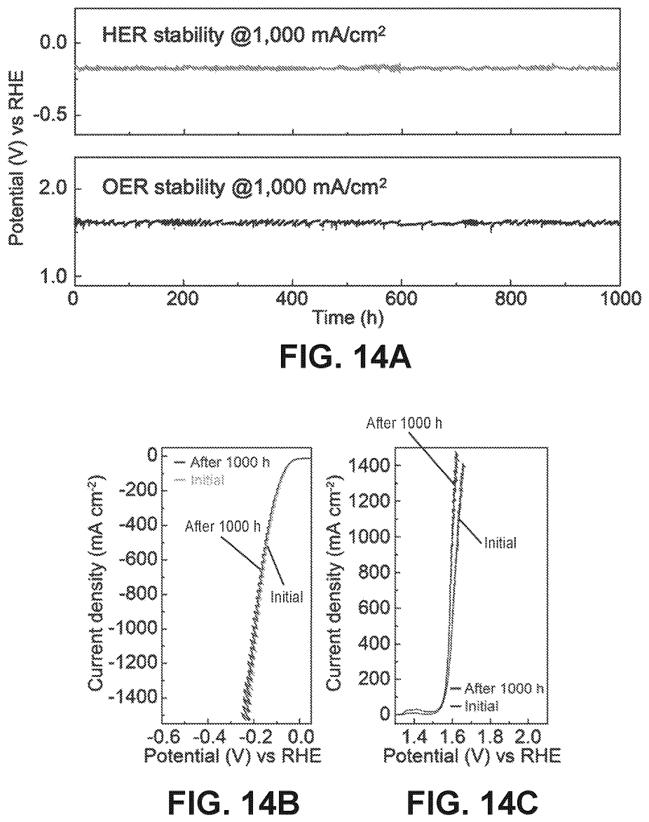

FIG. 14A illustrates the hydrogen evolution reaction (HER) and oxygen evolution reaction (OER) stability (in alkaline conditions, 1.0 M of KOH) of the electrode, according to some embodiments. This voltage stability test through constant current density was completed for HER and OER (half-cell) at 1000 mA/cm² for 1000 hours. Further, the electrolyte utilized was potassium hydroxide. As shown, the electrodes were stable even after 1000 hours. FIG. 14B illustrates a linear sweep voltammogram (LSV) of hydrogen evolution reaction (HER) performance, initially and after 1000 hours in alkaline conditions, according to some embodiments. As shown, the current density ranged from about −1600 mA/cm² to about 0 mA/cm². The Potential (V) vs RHE and current density increased with a positive correlation (reduced overpotential). Further, the electrolyte utilized was potassium hydroxide. Importantly, the electrode was stable even after 1000 hours. FIG. 14C illustrates an LSV of oxygen evolution reaction (OER) performance, initially and after 1000 hours in alkaline conditions, according to some embodiments. As shown, the current density ranges from about 0 mA/cm² to about 1400 mA/cm². The Potential (V) vs RHE and current density increased with a positive correlation (reduced overpotential). Further, the electrolyte utilized was potassium hydroxide. Importantly, the electrode was stable even after 1000 hours.

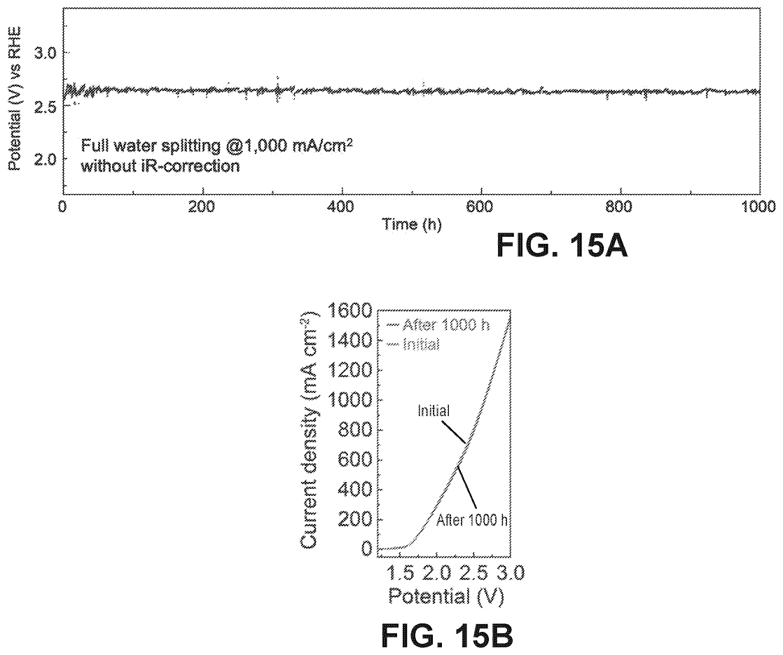

FIG. 15A illustrates full water splitting hydrogen evolution reaction and oxygen evolution reaction (HER+OER) electrodes 1000 hour stability test result at 1000 mA/cm² current density in alkaline conditions, according to some embodiments. These results are shown for full water splitting without iR-correction, and potassium hydroxide was utilized. As shown, from hour 0 to hour 1000, the Potential (V) vs. RHE remained stable and generally ranged from about 2.5 to 2.75. FIG. 15B illustrates an LSV of full water splitting stability test in alkaline conditions (1.0 M of KOH), according to some embodiments. As shown, the LSV curves are maintained even after 1000 hours in current density ranges from about 0 mA/cm² to about 1600 mA/cm². The current density and the Potential (V) increase with a positive correlation. As shown in FIG. 15A and FIG. 15B, the electrodes had excellent stability even after 1000 hours.

### Discussion of Possible Embodiments

An electrode composition includes one or more catalyst layers including one or more active catalytic metals and a tantalum oxide (TaₓO_{y}) support, and a substrate, wherein the one or more active catalytic metals include one or more of ruthenium, platinum, and iridium, and the one or more catalyst layers are in contact with the substrate.

The electrode composition of the preceding paragraph can optionally include, additionally and/or alternatively any one or more of the following features, configurations, and/or additional components.

The one or more active catalytic metals may include ruthenium and a secondary metal selected from one or more of iridium, cobalt, nickel, iron, palladium, platinum, copper, and molybdenum.

The ruthenium may be present from 1 wt. % to 30 wt. % of the total composition.

The tantalum oxide may include the formula Ta₂O₅.

The substrate may include one or more of titanium, nickel, stainless steel, lead, aluminum, and carbon.

The substrate may include a conducting material selected from oxide-free titanium and oxide-free stainless steel.

The one or more catalyst layers may further include one or more of titanium, tungsten, and zirconium.

The one or more catalyst layers may include two or more catalyst layers including the same active catalytic metals in each layer.

A method of making an electrode includes preparing an ink composition by contacting tantalum ethoxide or tantalum chloride with ruthenium chloride and an alcohol, coating the ink composition on a substrate, and heating the coated substrate.

The method of the preceding paragraph can optionally include, additionally and/or alternatively any one or more of the following features, configurations, and/or additional components.

The tantalum ethoxide or tantalum chloride may be present from 0.3 wt. % to 20 wt. % in the ink composition.

The method may further include contacting the ink composition with an adhesive selected from one or more of titanium n-butoxide, titanium isopropoxide, titanium chloride, tungsten chloride, tungsten alkoxide, and zirconium chloride.

The method may further include contacting the ink composition with hydrochloric acid.

The alcohol may include one or more of n-butanol, ethanol, and isopropanol.

The method may further include contacting the ink composition with one or more of iridium, cobalt, nickel, iron, palladium, platinum, copper, and molybdenum.

A system for electrochemical water splitting includes an anode sufficient for an oxygen evolution reaction, a cathode sufficient for a hydrogen evolution reaction, an electrical energy source connected to the anode and the cathode, and an electrolyte, wherein the anode includes one or more catalyst layers including one or more active catalytic metals and a tantalum oxide (Ta₂O₅) support.

The system of the preceding paragraph can optionally include, additionally and/or alternatively any one or more of the following features, configurations, and/or additional components.

The system may further include a reservoir sufficient for retaining the electrolyte.

The system may include a membrane or a diaphragm.

The membrane or the diaphragm may separate the cathode and the anode.

The membrane or the diaphragm may allow ion transport to one or more of the cathode and the anode.

The one or more active catalytic metals may include one or more of ruthenium, platinum, and iridium.

The ruthenium may be present from 1 wt. % to 30 wt. % of the one or more catalyst layers.

The anode may further include one or more of iridium, cobalt, nickel, iron, palladium, platinum, copper, and molybdenum.

The electrolyte may include a liquid alkaline electrolyte or an acidic electrolyte.

The cathode may include one or more catalyst layers including one or more active catalytic metals and a tantalum oxide support, wherein the one or more active catalytic metals includes a metal selected from ruthenium, platinum, and iridium.

The system may be a proton exchange membrane electrolysis system, an alkaline water electrolysis system, a high-temperature solid oxide water electrolysis system, or an anion exchange membrane electrolysis system.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

1. An electrode composition, the electrode composition comprising:
one or more catalyst layers including one or more active catalytic metals and a tantalum oxide (TaₓO_{y}) support; and
a substrate,
wherein the one or more active catalytic metals include one or more of ruthenium, platinum, and iridium, and the one or more catalyst layers are in contact with the substrate.

2. The electrode composition according to claim 1, wherein the one or more active catalytic metals include ruthenium and a secondary metal selected from one or more of iridium, cobalt, nickel, iron, palladium, platinum, copper, and molybdenum.

3. The electrode composition according to claim 1, wherein the one or more active catalytic metals include ruthenium, and the ruthenium is present from 1 wt. % to 30 wt. % of the electrode composition.

4. The electrode composition according to claim 1, wherein the tantalum oxide (TaₓO_{y}) support includes Ta₂O₅.

5. The electrode composition according to claim 1, wherein the substrate includes one or more of titanium, nickel, stainless steel, lead, aluminum, and carbon.

6. The electrode composition according to claim 1, wherein the substrate includes a conducting material selected from oxide-free titanium and oxide-free stainless steel.

7. The electrode composition according to claim 1, wherein the one or more catalyst layers further include one or more of titanium, tungsten, and zirconium.

8. The electrode composition according to claim 1, wherein the one or more catalyst layers includes two or more catalyst layers including the same active catalytic metals in each layer.

9. A method of making an electrode, the method comprising:
preparing an ink composition by contacting tantalum ethoxide or tantalum chloride with ruthenium chloride and an alcohol;
coating the ink composition on a substrate; and
heating the coated substrate.

10. The method according to claim 9, wherein the tantalum ethoxide or tantalum chloride is present from 0.3 wt. % to 20 wt. % in the ink composition.

11. The method according to claim 9, further including contacting the ink composition with an adhesive selected from one or more of titanium n-butoxide, titanium isopropoxide, titanium chloride, tungsten chloride, tungsten alkoxide, and zirconium chloride.

12. The method according to claim 9, further including contacting the ink composition with hydrochloric acid.

13. The method according to claim 9, wherein the alcohol includes one or more of n-butanol, ethanol, and isopropanol.

14. The method according to claim 9, further including contacting the ink composition with one or more of iridium, cobalt, nickel, iron, palladium, platinum, copper, and molybdenum.

15. A system for electrochemical water splitting, the system comprising:
an anode sufficient for an oxygen evolution reaction;
a cathode sufficient for a hydrogen evolution reaction;
an electrical energy source connected to the anode and the cathode; and
an electrolyte;
wherein the anode includes one or more catalyst layers including one or more active catalytic metals and a tantalum oxide (Ta₂O₅) support.

16. The system according to claim 15, wherein the one or more active catalytic metals include one or more of ruthenium, platinum, and iridium.

17. The system according to claim 16, wherein the one or more active catalytic metals include ruthenium, and the ruthenium is present from 1 wt. % to 30 wt. % of the one or more catalyst layers.

18. The system according to claim 15, wherein the anode further includes one or more of iridium, cobalt, nickel, iron, palladium, platinum, copper, and molybdenum.

19. The system according to claim 15, wherein the electrolyte includes a liquid alkaline electrolyte or an acidic electrolyte.

20. The system according to claim 15, wherein the cathode includes one or more catalyst layers including one or more active catalytic metals and a tantalum oxide support, wherein the one or more active catalytic metals includes a metal selected from ruthenium, platinum, and iridium.
